(19) United States
(12) Patent Application Publication
(10) Pub. No.: US 2024/0297309 A1
(43) Pub. Date: Sep. 5, 2024

(54) NEGATIVE ELECTRODE COLLECTOR AND CAN-TYPE SECONDARY BATTERY

(71) Applicant: LG ENERGY SOLUTION, LTD., Seoul (KR)

(72) Inventors: Yeon Beom JEONG, Daejeon (KR); Jae Won MOON, Daejeon (KR); Hyung Kyun YU, Daejeon (KR); Ki Hoon PAENG, Daejeon (KR); Seon Hyeong NA, Daejeon (KR)

(73) Assignee: LG ENERGY SOLUTION, LTD., Seoul (KR)

(21) Appl. No.: 18/593,201

(22) Filed: Mar. 1, 2024

(30) Foreign Application Priority Data
Mar. 3, 2023 (KR) 10-2023-0028787
Apr. 5, 2023 (KR) 10-2023-0044730
Apr. 21, 2023 (KR) 10-2023-0052680
May 4, 2023 (KR) 10-2023-0058313
Feb. 28, 2024 (KR) 10-2024-0028937

(51) Int. Cl. H01M 4/66; C25D 1/04; H01M 4/02; H01M 10/0587; H01M 50/107

(52) U.S. Cl. CPC H01M 4/661; H01M 10/0587; H01M 50/107; C25D 1/04; H01M 2004/021; H01M 2004/027

(57) ABSTRACT

A negative electrode collector applicable to a secondary battery has a thickness of about 6 μm to 10 μm and a work hardening exponent “n” of about 0.10 to 0.25, in which the work hardening exponent “n” is defined according to an Equation of σ=K×εn, wherein “σ” represents a true stress, “K” represents a strength factor, “ε” represents a true strain, and “n” is a work hardening exponent.

### CROSS-REFERENCE TO RELATED APPLICATIONS

This application is based on and claims priority from Korean Patent Application Nos. 10-2023-0028787, 10-2023-0044730, 10-2023-0052680, 10-2023-0058313 and 10-2024-0028937, filed on Mar. 3, 2023, Apr. 5, 2023, Apr. 21, 2023, May 4, 2023 and Feb. 28, 2024, respectively, with the Korean Intellectual Property Office, the disclosures of which are incorporated herein in their entireties by reference.

### TECHNICAL FIELD

The present disclosure relates to a negative electrode collector and a can-type secondary battery manufactured using the negative electrode collector.

### BACKGROUND

With the technical development and the rising demand for electric automobiles and energy storage systems (ESS), the demand for batteries useful as energy sources has increased rapidly, and in response, studies are being conducted on batteries that can meet various needs. Especially, as power sources of these devices, lithium secondary batteries are being vigorously studied, which have the high energy density and the excellent lifetime and cycle characteristics.

Meanwhile, in order to enhance the performance and safety of second batteries, improvements are being made on the characteristics of each of a positive electrode, a negative electrode, an electrolyte, and a separator.

### SUMMARY

The present disclose provides a negative electrode collector having mechanical properties suitable to be applied to a can-type secondary battery, and a can-type secondary battery manufactured using the negative electrode collector.

Embodiments of the present disclosure are not limited to those described above, and other embodiments that are not described herein can clearly be understood by one of ordinary skill in the art from the descriptions herein below.

According to an embodiment of the present disclosure, a negative electrode collector has a thickness of about 6 μm to 10 μm, and a work hardening exponent “n” of about 0.10 to 0.25 according to Equation 1 below,

$$σ = K \times ε n \qquad [ Equation 1 ]$$

(in Equation 1 above, “σ” represents a true stress, “K” represents a strength factor, “ε” represents a true strain, and “n” is a work hardening exponent).

According to an embodiment of the present disclosure, a dislocation density of the negative electrode collector is about 4×10⁷/mm² or more.

According to an embodiment of the present disclosure, a yield strength of the negative electrode collector is about 31 kgf/mm² or more.

According to an embodiment of the present disclosure, an elastic modulus of the negative electrode collector is about 130 GPa to 140 GPa.

According to an embodiment of the present disclosure, an elongation of the negative electrode collector is about 13% or more.

According to an embodiment of the present disclosure, the negative electrode collector may include a copper thin film. The copper thin film is an electrolytic copper foil, and the electrolytic copper foil has a drum side and an air side opposite to the drum side. The average size of grains included in the drum side is about 0.50 μm or less. The average size of gains included in the air side is about 0.68 μm or less. The average size of the grains included in the drum side is smaller than the average size of the grains included in the air side.

According to an embodiment of the present disclosure, the negative electrode collector has TC(200) and TC(220) of about 2.20 or less, where TC(200) and TC(220) are defined by Equation 2 below,

$$T C ( hkl ) = \frac{I ( hkl ) / {I}_{0} ( h k l )}{\frac{1}{4} ( \frac{I ( 111 )}{{I}_{0} ( 111 )} + \frac{I ( 200 )}{{I}_{0} ( 200 )} + \frac{I ( 220 )}{{I}_{0} ( 220 )} + \frac{I ( 311 )}{{I}_{0} ( 311 )} )} \qquad [ Equation 2 ]$$

(in Equation 2 above, I(hkl) represents a peak intensity of a (hkl) crystal plane in an XRD graph obtained by performing an X-ray diffraction analysis on the negative electrode collector at 25° C., and

I₀(hkl) represents a peak intensity of a (hkl) crystal plane in an XRD graph of a reference sample,

$$in which {I}_{0} ( 111 ) = 100 , {I}_{0} ( 200 ) = 46 , {I}_{0} ( 220 ) = 20 , and {I}_{0} ( 311 ) = 17 ) .$$

According to an embodiment of the present disclosure, the negative electrode collector has TC(111) of about 2.20 or less, which is defined by Equation 2 above. A ratio of TC(111) to TC(200) (TC(111)/TC(200)) is about 0.8 or more. The negative electrode collector has TC(311) of about 2.20 or less, which is defined by Equation 2 above.

According to an embodiment of the present disclosure, a ratio of TC(200) to a total sum of TC(111), TC(200), TC(220), and TC(311) defined by Equation 2 above is about 40% or less, and a ratio of a sum of TC(220) and TC(311) to the total sum of TC(111), TC(200), TC(220), and TC(311) is about 50% or more. A ratio of TC(111) to a total sum of TC(111), TC(200), TC(220), and TC(311) defined by Equation 2 above is about 20% or more.

According to an embodiment of the present disclosure, a can-type secondary battery includes: an electrode assembly including a negative electrode, a separator, and a positive electrode that are sequentially stacked and wound in one direction; and a can-shaped case that accommodates the electrode assembly. The can-shaped case may be cylindrical.

According to an embodiment of the present disclosure, the present disclosure provides a method of manufacturing a can-type secondary battery including: an electrode assembly including a negative electrode, a separator, and a positive electrode that are sequentially stacked and wound in one direction; and a can-shaped case that accommodates the electrode assembly. The negative electrode includes a negative electrode collector having a thickness of about 6 μm to 10 μm and a work hardening exponent “n” of about 0.10 to 0.25, in which the work hardening exponent “n” is defined according to Equation 1 below,

$$σ = K \times ε n \qquad [ Equation 1 ]$$

(in Equation 1 above, “σ” represents a true stress, “K” represents a strength factor, “ε” represents a true strain, and “n” is a work hardening exponent).

Since the negative electrode collector according to an embodiment of the present disclosure satisfies the thickness of about 6 μm to 10 μm and the work hardening exponent “n” of about 0.10 to 0.25, it has the high work hardening performance as compared to a negative electrode collector that does not satisfy the numerical ranges above, and therefore, has the high processability and the excellent mechanical properties, which are suitable to be applied to the can-type secondary battery. For example, the negative electrode collector of the present disclosure is elongated without undergoing crack/short even when deformed into the jelly roll shape and inserted into the can-shaped case.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

The present patent or patent application file contains at least one drawing executed in color. Copies of this patent or patent application publication with color drawing(s) will be provided by the Office upon request and payment of the necessary fee.

FIG. 1 is a view illustrating a secondary battery according to an embodiment of the present disclosure.

FIG. 2 is a view illustrating a structure of a cap assembly according to an embodiment of the present disclosure.

FIG. 3 is an EBSD inverse pole figure (IPF) map obtained by capturing an image of an air side of an electrolytic copper foil of Example 1 at a 2000× magnification.

FIG. 4 is an EBSD inverse pole figure (IPF) map obtained by capturing an image of an air side of an electrolytic copper foil of Example 2 at a 2000× magnification.

FIG. 5 is an EBSD inverse pole figure (IPF) map obtained by capturing an image of an air side of an electrolytic copper foil of Example 3 at a 2000× magnification.

FIG. 6 is an EBSD inverse pole figure (IPF) map obtained by capturing an image of an air side of an electrolytic copper foil of Comparative Example 3 at a 2000× magnification.

FIG. 7 is an EBSD inverse pole figure (IPF) map obtained by capturing an image of an air side of an electrolytic copper foil of Comparative Example 4 at a 2000× magnification.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

The advantages and features of the present disclosure and methods for implementing them will be clearly understood from embodiments to be described in detail later with reference to the accompanying drawings. However, the present disclosure is not limited to the embodiments, but may be implemented in various forms. The embodiments are provided only to thoroughly describe the present disclosure and comprehensively inform the scope of the present disclosure to one of ordinary skill in the art to which the present disclosure belongs, and the present disclosure can be defined by the scope described in the claims. Throughout the descriptions herein, the same reference numeral refers to the same components.

Unless otherwise defined, all terms (including technical and scientific terminologies) used in the descriptions herein have meanings that can be commonly understood by those with ordinary skill in the art to which the present disclosure belongs. Further, terms commonly used and defined in dictionaries should not be interpreted ideally or over interpreted unless they are not explicitly defined.

The terms used herein are intended to describe embodiments of the present disclosure, and should not be construed as limiting the present disclosure. In the descriptions herein, a singular word includes the plural unless otherwise defined. As used herein, the terms “comprises” and/or “comprising” do not exclude the presence or addition of one or more other components in addition to a specific component.

In the descriptions herein, when a part “includes” a specific component, this description does not indicate that the part excludes other components, but indicates that the part may further include other components, unless otherwise defined.

In the descriptions herein, the expression “A and/or B” indicates “A or B, or A and B.”

In the descriptions herein, “%” indicates “% by weight” unless otherwise indicated.

In the descriptions herein, the terms “about,” “approximately,” and “substantially” are used to describe a range of numerical values or a degree, or an approximation thereto in consideration of inherent manufacturing and material tolerances, and are intended to prevent infringers from unfairly taking advantage of the present disclosure that describes precise or absolute numerical values to aid the understanding of the present disclosure.

### <Overview>

In general, according to the materials of battery cases, lithium secondary batteries are classified into can-type batteries in which an electrode assembly is embedded in a cylindrical or prismatic metal can, and pouch type batteries in which an electrode assembly is embedded in a pouch-shaped case made of an aluminum laminate sheet. The electrode assembly is a rechargeable power generation element that includes a positive electrode, a negative electrode, and a separator interposed between the positive and negative electrodes. Here, the negative electrode may have a structure in which a negative electrode collector and a negative electrode active material layer are sequentially stacked, and typically, a copper foil may be used as the negative electrode collector.

Meanwhile, in a can-type battery, the stress concentration appears in the transverse direction due to its structural feature, and hence, when a negative electrode collector is designed without considering this directionality, and thus, a negative electrode collector with a conspicuous particular directionality is applied, short may occur in the negative electrode, which degrades the lifetime performance of the battery. The present disclosure designs the negative electrode collector by taking into account mechanical properties of the negative electrode collector such as elongation and strength, and provides the negative electrode collector having the high elongation and strength, which are suitable to be applied to the can-type battery.

### <Negative Electrode Collector>

The work hardening exponent “n” of a negative electrode collector according to an embodiment of the present disclosure is about 0.10 to 0.25. In the descriptions herein, the “work hardening exponent ‘n’” refers to the slope of the true stress “σ”-true strain “ε” curve, and is defined by Equation 1 below.

$$σ = K \times {ε}^{n} \qquad [ Equation 1 ]$$

In Equation 1 above, “σ” represents the true stress, “K” represents the strength factor, “ε” represents the true strain, and “n” represents the work hardening exponent. The true stress indicates a value obtained by dividing a load acting on a material by the actual area of the cross-sectional area to which the load is applied. The true strain “ε” indicates a value obtained by dividing a deformation amount of a material by the length of the material after the deformation. The work hardening exponent “n” indicates the slope of the true stress-true strain curve. The work hardening exponent “n” may be calculated from the stress-strain curve obtained by performing a tensile test using an extensometer (manufactured by: ZwickRoell, product name: videoXtens biax 2-150 HP). The extensometer may be a measurement device useful for measuring the elongation of the negative electrode collector in a state where a load is applied to the negative electrode collector.

Meanwhile, the thickness of the negative electrode collector according to an embodiment of the present disclosure is about 6 μm to 10 μm, or 6 μm to 8 μm. When the thickness of the negative electrode collector satisfies this numerical range, the size of grains included in the collector becomes coarse relative to the thickness of the collector, and therefore, dislocations easily move and pile up at the grains. Here, the “grain” indicates a single crystal grain unit having a regular arrangement of atoms.

As a result, for example, the negative electrode collector applied to the can-type secondary battery may fracture early before sufficiently deformed.

In order to resolve this problem, the inventors of the present disclosure have adjusted the value of the work hardening exponent “n” according to Equation 1 above in designing the negative electrode collector, and verified that the strength and elongation of the negative electrode collector, which are suitable to be applied to the can-type secondary battery, can be ensured when the value of the work hardening exponent “n” satisfies the appropriate range of, for example, about 0.10 to 0.25. The work hardening exponent “n” of the negative electrode collector may be controlled, for example, by adjusting the kind or content of component to be added, and the condition of heat treatment.

Thus, the work hardening exponent “n” of the negative electrode collector according to an embodiment of the present disclosure is about 0.10 to 0.25, for example, about 0.10 to 0.20, or about 0.12 to 0.16.

When the work hardening exponent “n” of the negative electrode collector according to an embodiment of the present disclosure satisfies the range of about 0.10 to 0.25 as described above, the negative electrode collector may be adequately hardened as being worked, ensuring the sufficient strength. Thus, when applied to the can-type secondary battery, the negative electrode collector may withstand the manufacturing process, and further, prevent the occurrence of crack or short even under a constant load. Further, since the grains are adjusted to have the adequate size, the sufficient elongation is ensured, so that when applied to the can-type secondary battery, the negative electrode collector does not fracture even under a repeated load.

According to an embodiment of the present disclosure, the dislocation density of the negative electrode collector is about 4.0×10⁷/mm² or more, about 4.0×10⁷/mm² to 5.5×10⁷/mm², about 4.0×10⁷/mm² to 5.3×10⁷/mm², or about 4.0×10⁷/mm² to 4.5×10⁷/mm². The dislocation density indicates the total dislocation length per unit volume.

The dislocation density may be calculated from the full width at half maximum (FWHM) measured for each peak in an XRD graph obtained by performing an X-ray diffraction analysis on the negative electrode collector.

For example, the X-ray diffraction (XRD) analysis is performed at 25° C. to obtain the XRD graph of the negative electrode collector. The X-ray diffraction analysis may be performed using an X-ray diffractometer (Bruker AXS D4 Endeavor) at 25° C. under the following conditions.
Source: Cu radiation (Kα₁:Kα₂=8:2)
2θ: 40° to 91°
Step size: 0.0015°/s
Total scan time: 168 min
Voltage: 40 kV
Current: 40 mA

Next, the full width at half maximum (FWHM) is calculated from the peak of each (hkl) crystal plane in the obtained XRD graph.

The full width at half maximum (FWHM) indicates the difference between two 2θ values equal to half of the maximum magnitude value of each peak. For example, the FWHM is measured from the peak of the (111) crystal plane of the negative electrode collector that is identified in a measurement range where 2θ is about 42° to 45°. The FWHM is measured from the peak of the (200) crystal plane of the negative electrode collector that is identified in a measurement range where 2θ is about 49° to 52°. The FWHM is measured from the peak of the (220) crystal plane of the negative electrode collector that is identified in a measurement range where 2θ is about 73º to 76°. The FWHM is measured from the peak of the (311) crystal plane of the negative electrode collector that is identified in a measurement range where 2θ is about 89° to 91°.

Next, the dislocation density of the negative electrode collector may be calculated from the FWHM measured by the method described above.

At this time, the dislocation density may be calculated by the following method. For example, in the present disclosure, the dislocation density may be calculated by, but not limited to, at least one method among the Scherrer method, the uniform deformation model (UDM), the uniform stress deformation model (USDM), the uniform deformation energy density model (UDEDM), the Williamson-Hall analysis, and models using the equation of modified Warren-Abelbach and the equation of modified Williamson-Hall. When the dislocation density of the negative electrode collector satisfies the numerical range above, the negative electrode collector has fine grains, which suppresses the movement of dislocations and the pile-up of dislocations at the grains, so that the elongation is improved, and the deformation behavior becomes smooth.

In an embodiment of the present disclosure, the yield strength of the negative electrode collector is about 31 kgf/mm² or more, for example, about 31 kgf/mm² to 32 kgf/mm², or 31 kgf/mm² to 31.5 kgf/mm². The yield strength indicates the maximum stress that can be applied to a material without causing a plastic deformation. The yield strength of the negative electrode collector may be measured using an extensometer (manufactured by: ZwickRoell, product name: videoXtens biax 2-150 HP). When the yield strength of the negative electrode collector satisfies the numerical range above, the negative electrode collector may be prevented from cracking or fracturing when applied to the can-type secondary battery in which the stress concentrates in the transverse direction.

In an embodiment of the present disclosure, the elastic modulus of the negative electrode collector is about 130 GPa to 140 GPa, for example, about 130 GPa to 135 GPa, or about 130 GPa to 133 GPa. The elastic modulus indicates the slope of an elastic region in the stress-strain curve obtained by performing the tensile test. The elastic modulus of the negative electrode collector may be measured using an extensometer (manufactured by: ZwickRoell, product name: videoXtens biax 2-150 HP). When the elastic modulus of the negative electrode collector satisfies the numerical range above, the sufficient work hardening performance is ensured, so that the negative electrode collector may withstand the load taking place during the process, which achieves the excellent durability.

In an embodiment of the present disclosure, the elongation of the negative electrode collector is about 13% or more, for example, about 3% to 18%, or about 13% to 16%. The elongation indicates the true strain of the negative electrode collector. The elongation of the negative electrode collector may be measured using an extensometer (manufactured by: ZwickRoell, product name: videoXtens biax 2-150 HP). When the elongation of the negative electrode collector satisfies the numerical range above, the deformation behavior of the negative electrode collector becomes smooth, so that the occurrence of short or crack may be prevented even when the negative electrode collector is applied to the can-type secondary battery.

Meanwhile, additional properties of the negative electrode collector according to the present disclosure may be verified from the texture coefficient at a specific crystal plane of the negative electrode collector.

The texture coefficient TC(hkl) of the negative electrode collector according to an embodiment of the present disclosure indicates the texture coefficient at a (hkl) crystal plane of the negative electrode collector, which is calculated using the XRD graph obtained by performing the X-ray diffraction analysis on the negative electrode collector at 25° C., and is defined by Equation 2 below.

$$T C ( hkl ) = \frac{I ( hkl ) / {I}_{0} ( hkl )}{\frac{1}{4} ( \frac{I ( 111 )}{{I}_{0} ( 111 )} + \frac{I ( 200 )}{{I}_{0} ( 200 )} + \frac{I ( 220 )}{{I}_{0} ( 220 )} + \frac{I ( 311 )}{{I}_{0} ( 311 )} )} \qquad [ Equation 2 ]$$

(In Equation 2 above, I(hkl) represents the peak intensity of the (hkl) crystal plane in the XRD graph obtained by performing the X-ray diffraction analysis on the negative electrode collector at 25° C., and

I₀(hkl) represents the peak intensity of the (hkl) crystal plane in the XRD graph of a reference sample,

in which I₀(111)=100, I₀(200)=46, I₀(220)=20, and I₀(311)=17.)

For example, the texture coefficient TC(hkl) of the negative electrode collector may be calculated as follows.

First, the X-ray diffraction (XRD) analysis is performed at 25° C. to obtain the XRD graph of the negative electrode collector, and the texture coefficients at the (111) crystal plane, the (200) crystal plane, the (220) crystal plane, and the (311) crystal plane of the negative electrode collector may be calculated using Equation 2 above. At this time, the X-ray diffraction analysis may be performed using the X-ray diffractometer (Bruker AXS D4 Endeavor) at 25° C. under the following conditions.
Source: Cu radiation (Kα₁:Kα₂=8:2)
2θ: 40° to 91°
Step size: 1.5°/min
Total scan time: 64 min
Voltage: 40 kV
Current: 40 mA

Next, the peak intensity I(hkl) of each (hkl) crystal plane is calculated from the obtained XRD graph. For example, the peak intensity of the (111) crystal plane of the negative electrode collector may be measured in the measurement range where 2θ is about 42° to 45°. The peak intensity of the (200) crystal plane of the negative electrode collector may be measured in the measurement range where 2θ is about 49° to 52°. The peak intensity of the (220) crystal plane of the negative electrode collector may be measured in the measurement range where 2θ is about 73° to 76°. The peak intensity of the (311) crystal plane of the negative electrode collector may be measured in the measurement range where 2θ is about 89° to 91°.

Next, the peak intensity of the (hkl) crystal plane in the XRD graph of the reference sample is calculated. For example, the XRD diffraction peak intensity I₀(hkl) is calculated for each crystal plane of a standard powder defined according to the International Center for Diffraction Data (ICDD).

Last, the arithmetic mean value of I(hkl)/I₀(hkl) for all of the crystal planes is calculated, and then, I(hkl)/I₀(hkl) at a specific (hkl) plane is divided by the arithmetic mean value to obtain the texture coefficient TC(hkl) at the specific (hkl) plane.

The negative electrode collector according to an embodiment of the present disclosure has TC(200) and TC(220) of about 2.20 or less, which are defined by Equation 2 above. For example, TC(200) and TC(220) are about 0.40 to 2.20, about 0.50 to 1.80, or about 0.80 to 1.80. When the negative electrode is manufactured by selecting the negative electrode collector with TC(200) and TC(220) that satisfy the numerical range above, the stress may be prevented from concentrating in the particular direction of the negative electrode collector. Accordingly, the short of the negative electrode may be prevented even when the negative electrode collector is applied to the can-type secondary battery in which the stress concentrates in the transverse direction. That is, by adjusting TC(200) and/or TC(220) to about 2.20 or less, it is possible to prevent the phenomenon that the directionality of the negative electrode in the particular direction becomes conspicuous, and for example, the negative electrode collector may fully withstand the process even when applied to the can-type secondary battery in which the stress concentrates in the transverse direction, which may eliminate the problem of the occurrence of short.

In an embodiment of the present disclosure, TC(111) and/or TC(311) of the negative electrode collector as well as TC(200) and TC(220) are 2.20 or less. For example, TC(111) is about 0.80 to 1.80, and TC(311) is about 0.40 to 2.20, or about 0.50 to 1.80. In this way, it may be verified that the stress does not concentrate in the particular direction of the negative electrode collector when the texture coefficients at all of the crystal planes of the negative electrode collector are 2.20 or less.

Meanwhile, in the negative electrode collector according to an embodiment of the present disclosure, when TC(111) is maintained at about 0.80 or more, the sufficient deformation amount may be ensured, and the negative electrode collector suitable to be applied to the can-type secondary battery may be designed.

In the negative electrode collector according to an embodiment of the present disclosure, for example, the ratio of TC(111) to TC(200) (TC(111)/TC(200)) is about 0.8 or more, about 0.9 or more, about 1.0 or more, or about 1.0 to 2.0. When TC(111)/TC(200) satisfies this numerical range, more excellent mechanical properties may be obtained to be applied to the can-type secondary battery.

Meanwhile, in the negative electrode collector according to an embodiment of the present disclosure, the ratio of TC(200) to the total sum of TC(111), TC(200), TC(220), and TC(311) is adjusted to about 40% or less, for example, less than about 35%, less than about 30%, or about 25% to 30%. When the ratio of TC(200) to the total sum of TC(111), TC(200), TC(220), and TC(311) satisfies this numerical range, the particular directionality of the negative electrode collector does not become conspicuous, which may ensure the mechanical properties that may withstand the process when applied to the can-type secondary battery in which the stress concentrates in the transverse direction.

In the negative electrode collector according to an embodiment of the present disclosure, the ratio of the sum of TC(220) and TC(311) to the total sum of TC(111), TC(200), TC(220), and TC(311) is adjusted to about 50% or more, for example, about 50% to 65%, about 50% to 60%, or about 53% to 60%. When the ratio of the sum of the texture coefficients of the (200) crystal plane and the (311) crystal plane to the total sum of the texture coefficients of the (111) crystal plane, the (200) crystal plane, the (220) crystal plane, and the (311) crystal plane is adjusted to about 50% or more, the slip transfer efficiency (Schmid Factor) does not decrease, and the mechanical deformation behavior of the negative electrode collector becomes smooth, which may optimize the tensile strength and the elongation. As a result, even when the negative electrode collector is applied to the can-type secondary battery in which the stress concentrates in the transverse direction, the negative electrode collector may adequately withstand the process, and therefore, may be prevented from cracking or fracturing.

In the negative electrode collector according to an embodiment of the present disclosure, the ratio of TC(111) to the total sum of TC(111), TC(200), TC(220), and TC(311) is about 20% or more, for example, about 20% to 30%, or about 22% to 30%.

Meanwhile, the negative electrode collector according to an embodiment of the present disclosure has the conductivity without causing chemical changes in the battery. The negative electrode collector is, for example, a copper, a stainless steel, aluminum, nickel, titanium, heat-treated carbon, a copper or a stainless steel with its surface processed with carbon, nickel, titanium, silver or the like, or an aluminum-cadmium alloy. For example, the negative electrode collector may include a copper thin film. In this case, the copper thin film is an electrolytic copper foil. The copper thin film is, for example, an electrolytic copper foil manufactured by an electrolytic plating process. When the copper thin film is manufactured by the electrolytic plating process, the thickness of the negative electrode collector may be thinned, and the energy density of the battery may be improved.

The negative electrode collector according to an embodiment of the present disclosure is a commercially available negative electrode collector, or is manufactured by a manufacturing method of a negative electrode collector well-known in the art such as a manufacturing method of an electrolytic copper foil. For example, the manufacturing method of the electrolytic copper foil may be performed as follows. First, a reaction tank is prepared, which is equipped with a negative electrode rotating drum and a positive electrode plate disposed facing the negative electrode rotating drum, and the reaction tank is filled with an electrolyte obtained by mixing copper sulfate and water. Next, the negative electrode rotating drum is rotated in a state where electricity is applied to the negative electrode rotating drum and the positive electrode plate, to make the copper electrodeposited onto the surface of the negative electrode rotating drum. Then, the electrodeposited copper is continuously extracted from the reaction tank to obtain a copper thin film. The obtained copper thin film is rolled through a roll press process, and the rolled copper thin film may be slit and sheeted to produce a copper collector.

In the electrolytic copper foil manufactured according to the method described above, one side of the electrolytic copper foil in contact with the negative electrode rotating drum is referred to as a drum side, and the opposite side to the drum side is referred to as an air side.

The average size of grains included in the drum side is about 0.50 μm or less, for example, about 0.40 μm to 0.50 μm, or about 0.45 μm to 0.50 μm. The average size of grains included in the air side is about 0.68 μm or less, for example, about 0.60 μm to 0.68 μm, or about 0.63 μm to 0.68 μm. The average size of grains indicates the average size of grains that are clearly separated by high angle grain boundaries, and may be measured by calculating the Misorientation angle using the electron backscatter diffraction (EBSD). When the average size of the grains included in each of the drum side and the air side satisfies the numerical range above, the number of grains in the thickness direction of the electrolytic copper foil is secured, forming the microstructural bimodal structure, so that dislocations pile up only at coarse grains, and fine grains suppress the movement of dislocations. As a result, both the high tensile strength value and the improved elongation may be achieved, and the mechanical properties suitable for the can-type secondary battery may be obtained.

In an embodiment of the present disclosure, the average size of the grains included in the drum side is smaller than the average size of the grains included in the air side. In this case, the movement of dislocations is hindered by the fine grains included in the drum side, and dislocations pile up at the coarse grains included in the air side, which further facilitates the plastic deformation of the electrolytic copper foil, and as a result, improves the elongation and the strength of the electrolytic copper foil.

The negative electrode collector according to an embodiment of the present disclosure may include fine irregularities on its surface, to enhance the bonding to the negative electrode active material. For example, the negative electrode collector may be manufactured in various forms such as a film, a sheet, a foil, a net, a porous material, a foam, and a nonwoven.

### <Can-Type Secondary Battery>

Next, the can-type secondary battery according to an embodiment of the present disclosure will be described.

The can-type secondary battery of the present disclosure includes an electrode assembly and a can-shaped case accommodating the electrode assembly. The electrode assembly includes a negative electrode, a separator, and a positive electrode, which are sequentially stacked and wound in one direction. The negative electrode includes the negative electrode collector described above.

According to an embodiment of the present disclosure, the negative electrode may include a negative electrode collector and a negative electrode active material layer formed on the negative electrode collector. In this case, the negative electrode collector is the negative electrode collector according to the present disclosure.

According to an embodiment of the present disclosure, the negative electrode may not form the negative electrode active material layer on the negative electrode collector. For example, the negative electrode may be the negative electrode collector itself manufactured according to the present disclosure, or may have a structure in which a specific metal is physically bonded, rolled, or deposited on the negative electrode collector. As for the deposition method, an electrodeposition or a chemical vapor deposition may be performed on the specific metal. In this case, the specific metal bonded/rolled/deposited on the negative electrode collector includes one metal or an alloy of two metals selected from the group consisting of lithium (Li), nickel (Ni), tin (Sn), copper (Cu), and indium (In).

The negative electrode active material layer of the present disclosure may include a negative electrode active material, and may further include, for example, a conductive agent and a binder as necessary.

The negative electrode active material may include at least one selected from the group consisting of a lithium metal, a carbon material allowing the reversible intercalation/deintercalation of lithium ions, metals or alloys of the metals and lithium, a metal complex oxide, a material capable of doping and de-doping lithium, and a transition metal oxide.

As for the carbon material allowing the reversible intercalation/deintercalation of lithium ions, any carbon-based negative electrode active material commonly used in lithium ion secondary batteries may be used without particular limitation, and representative examples thereof include crystalline carbon, amorphous carbon, and combinations thereof. Examples of the crystalline carbon include graphite such as natural or artificial graphite in an amorphous, plate, flake, spherical, or fibrous form, and examples of the amorphous carbon include soft carbon (low temperature calcined carbon) or hard carbon, mesophase pitch carbide, and calcined cokes.

The metals or alloys of the metals and lithium may be metals or alloys of the metals and lithium selected from the group consisting of Cu, Ni, Na, K, Rb, Cs, Fr, Be, Mg, Ca, Sr, Si, Sb, Pb, In, Zn, Ba, Ra, Ge, Al, and Sn.

The metal complex oxide may be one selected from the group consisting of PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, LixFe₂O₃ (0≤x≤1), LiₓWO₂ (0≤x≤1), and SnₓMe₁₋ₓMe′_{y}O_{z} (Me: Mn, Fe, Pb, Ge; Me′: Al, B, P, Si; the elements of Groups 1, 2, 3 of the periodic table, halogen; 0<x≤1; 1≤y≤3; 1≤z≤8).

The material capable of doping and de-doping lithium may be, for example, Si, SiOₓ (0<x≤2), a Si—Y alloy (in which Y is an element selected from the group consisting of alkali metals, alkaline earth metals, the elements of Groups 13 and 14, transition metals, rare earth elements, and combinations thereof, but is not Si), Sn, SnO₂, or a Sn—Y (in which Y is an element selected from the group consisting of alkali metals, alkaline earth metals, the elements of Groups 13 and 14, transition metals, rare earth elements, and combinations thereof, but is not Sn), or may be a combination of at least one of these compounds and SiO₂. The element Y may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and combinations thereof.

The transition metal oxide may be, for example, a lithium-containing titanium composite oxide (LTO), vanadium oxide, or lithium vanadium oxide.

The negative electrode active material may be contained in a content of about 60 wt % to 99 wt %, for example, about 70 wt % to 99 wt %, or about 80 wt % to 98 wt % based on the total weight of the negative electrode active material layer.

The negative electrode conductive agent is a component that further improves the conductivity of the negative electrode active material, and is not particularly limited as long as it has the conductivity without causing chemical changes in the battery. For example, the following conductive material may be used: carbon powder such as carbon black, acetylene black, ketchen black, channel black, furnace black, lamp black, or thermal black; graphite powder such as natural graphite with a well-developed crystalline structure, artificial graphite, or graphite; conductive fiber such as carbon fiber or metal fiber; carbon fluoride powder; conductive powder such as aluminum powder or nickel powder; conductive whisker such as zinc oxide or potassium titanate; a conductive metal oxide such as titanium oxide; or a polyphenylene derivative.

The negative electrode conductive agent may be contained in a content of about 1 wt % to 20 wt %, for example, about 1 wt % to 15 wt %, or about 1 wt % to 10 wt % based on the total weight of the negative electrode active material layer.

The negative electrode binder is a component that assists the bonding among the negative electrode conductive agent, the negative electrode active material, and the negative electrode collector. Examples of the binder include polyvinylidene fluoride (PVDF), polyvinyl alcohol, carboxymethylcellulose (CMC), starch, hydroxypropylcellulose, regenerated cellulose, polyvinylpyrrolidone, polyethylene, polypropylene, an ethylene-propylene-diene monomer, a sulfonated ethylene-propylene-diene monomer, a styrene-butadiene rubber, a fluorinated rubber, and various copolymers thereof.

Typically, the negative electrode binder may be contained in a content of about 1 wt % to 20 wt %, for example, about 1 wt % to 15 wt %, or about 1 wt % to 10 wt % based on the total weight of the negative electrode active material layer.

Meanwhile, the positive electrode may include a positive electrode collector, and a positive electrode active material layer formed on the positive electrode collector.

The positive electrode collector is not particularly limited as long as it has the conductivity without causing chemical changes in the battery. For example, the positive electrode collector may be a stainless steel, aluminum, nickel, titanium, calcined carbon, or aluminum or a stainless steel with its surface processed with carbon, nickel, titanium, silver or the like.

The positive electrode collector may have the thickness of about 3 μm to 500 μm, and may include fine irregularities on the surface thereof to enhance the bonding to the positive electrode active material layer. For example, the positive electrode collector may be manufactured in various forms such as a film, a sheet, foil, a net, a porous material, a foam, and a nonwoven.

The positive electrode active material layer may include a positive electrode active material, and may further include, for example, a conductive agent and a binder as necessary.

The positive electrode active material is a compound allowing the reversible intercalation/deintercalation of lithium, and may include a lithium metal oxide containing lithium and one or more metals among cobalt, manganese, nickel, and aluminum. For example, the lithium metal oxide may include one compound or two or more compounds among a lithium-manganese-based oxide (e.g., LiMnO₂ and LiMn₂O₄), a lithium-cobalt-based oxide (e.g., LiCoO₂), a lithium-nickel-based oxide (e.g., LiNiO₂), a lithium-nickel-manganese-based oxide (e.g., LiNi_{1-Y}Mn_{Y}O₂ (where 0<Y<1) and LiMn_{2-Z}Ni_{Z}O₄ (where 0<Z<2)), a lithium-nickel-cobalt-based oxide (e.g., LiNi_{1-Y1}Co_{Y1}O₂ (where 0<Y1<1)), a lithium-manganese-cobalt-based oxide (e.g., LiCo_{1-Y2}Mn_{Y2}O₂ (where 0<Y2<1) and LiMn_{2-Z1}Co_{Z1}O₄ (where 0<Z1<2)), a lithium-nickel-manganese-cobalt-based oxide (e.g., Li(NiₚCo_{q}Mnᵣ)O₂ (where 0<p<1, 0<q<1, 0<r<1, and p+q+r=1) and Li(Niₚ₁Co_{q1}Mnᵣ₁)O₄ (where 0<p1<2, 0<q1<2, 0<r1<2, and p1+q1+r1=2)), a lithium-nickel-cobalt-transition metal (M) oxide (e.g., Li(Niₚ₂Co_{q2}Mnᵣ₂Mₛ₂)O₂ (where M is selected from the group consisting of Al, Fe, V, Cr, Ti, Ta, Mg, and Mo, p2, q2, r2, and s2 are each an atomic fraction of an independent element and satisfy 0<p2<1, 0<q2<1, 0<r2<1, 0<s2<1, and p2+q2+r2+s2=1)), and a lithium iron phosphate (e.g., Li₁₊ₐFe₁₋ₓMₓ(PO_{4-b})X_{b} (where M is at least one species selected from Al, Mg, and Ti, X is at least one species selected from F, S, and N, and −0.5≤a≤0.5, 0≤x≤0.5, and 0≤b≤0.1).

Among the compounds above, from the view point of enhancing the capacity characteristics and the safety of the battery, the lithium metal oxide may be any one compound or a mixture of two or more compounds among LiCoO₂, LiMnO₂, LiNiO₂, lithium nickel manganese cobalt oxide (e.g., Li(Ni_{1/3}Mn_{1/3}Co_{1/3})O₂, Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, and Li(Ni_{0.8}Mn_{0.1}Co_{0.1})O₂), lithium nickel cobalt aluminum oxide (e.g., Li(Ni_{0.8}Co_{0.15}Al_{0.05})O₂), lithium nickel manganese cobalt aluminum oxide (e.g., Li(Ni_{0.86}Co_{0.05}Mn_{0.07}Al_{0.02})O₂), and lithium iron phosphate (e.g., LiFePO₄).

The positive electrode active material may be contained in a content of about 60 wt % to 99 wt %, for example, about 70 wt % to 99 wt %, or about 80 wt % to 98 wt % based on the total weight of the positive electrode active material layer.

The positive electrode conductive agent is a component that further improves the conductivity of the positive electrode active material, and is not particularly limited as long as it has the conductivity without causing chemical changes in the battery. For example, the following conductive material may be used: carbon powder such as carbon black, acetylene black, ketchen black, channel black, furnace black, lamp black, or thermal black; graphite powder such as natural graphite with a well-developed crystalline structure, artificial graphite, or graphite; conductive fiber such as carbon fiber or metal fiber; carbon fluoride powder; conductive powder such as aluminum powder or nickel powder; conductive whisker such as zinc oxide or potassium titanate; a conductive metal oxide such as titanium oxide; or a polyphenylene derivative.

Typically, the positive electrode conductive agent may be contained in a content of about 1 wt % to 20 wt %, for example, about 1 wt % to 15 wt %, or about 1 wt % to 10 wt % based on the total weight of the positive electrode active material layer.

The positive electrode binder is a component that assists the bonding among the positive electrode conductive agent, the positive electrode active material, and the positive electrode collector.

Examples of the positive electrode binder include polyvinylidene fluoride (PVDF), polyvinyl alcohol, carboxymethylcellulose (CMC), starch, hydroxypropylcellulose, regenerated cellulose, polyvinylpyrrolidone, polyethylene, polypropylene, an ethylene-propylene-diene monomer, a sulfonated ethylene-propylene-diene monomer, a styrene-butadiene rubber, a fluorinated rubber, and various copolymers thereof.

Typically, the positive electrode binder may be contained in a content of about 1 wt % to 20 wt %, for example, about 1 wt % to 15 wt %, or about 1 wt % to 10 wt % based on the total weight of the positive electrode active material layer.

Meanwhile, the separator is not particularly limited as long as it is commonly used in secondary batteries, and for example, may have a low resistance to the ion transport by the electrolyte and an excellent electrolyte impregnation ability.

For example, the separator may be a porous polymer film including a polyolefin-based polymer such as ethylene homopolymer, propylene homopolymer, ethylene/butene copolymer, ethylene/hexene copolymer, or ethylene/methacrylate copolymer, or a stacked structure of two or more thereof. Further, the separator may be a common porous nonwoven, for example, a nonwoven made of a glass fiber with a high melting point or polyethyleneterephthalate fiber.

The secondary battery according to an embodiment of the present disclosure may include an electrolyte. In this case, the electrolyte may be a nonaqueous electrolyte. The nonaqueous electrolyte may include, but is not particularly limited to, an organic solvent and lithium salt which are commonly used in the art.

The organic solvent is not particularly limited as long as it serves as a medium that transports ions involved in the electrochemical reaction of the battery. For example, the organic solvent may be an ester-based solvent such as methyl acetate, ethyl acetate, γ-butyrolactone, or ε-caprolactone; an ether-based solvent such as dibutyl ether or tetrahydrofuran; a ketone-based solvent such as cyclohexanone; an aromatic hydrocarbon-based solvent such as benzene or fluorobenzene; or a carbonate-based solvent such as dimethyl carbonate (DMC), diethyl carbonate (DEC), methylethyl carbonate (MEC), ethylmethyl carbonate (EMC), ethylene carbonate (EC), or propylene carbonate (PC).

Among these compounds, the carbonate-based solvent may be used, or a mixture of the following compounds may be used: cyclic carbonate (e.g., ethylene carbonate or propylene carbonate) exhibiting the high ion conductivity and the high dielectric constant that can improve the charge and discharge performance of the battery, and a linear carbonate-based compound (e.g., ethylmethylcarbonate, dimethylcarbonate, or diethylcarbonate) having the low viscosity.

The lithium salt is not particularly limited as long as it is a compound that can provide lithium ions used in lithium secondary batteries. For example, the lithium salt may be LiPF₆, LiClO₄, LiAsF₆, LiBF₄, LiSbF₆, LiA₁₀₄, LiAICI₄, LiCF₃SO₃, LiC₄F₉SO₃, LiN(C₂F₅SO₃)₂, LiN(C₂F₅SO₂)₂, LiN(CF₃SO₂)₂. LiCl, LiI, or LiB(C₂O₄)₂. The lithium salt may be contained at a concentration of about 0.6 mol % to 2 mol % in the electrolyte.

Meanwhile, the nonaqueous electrolyte according to the present disclosure may include additives as necessary, in order to further improve the properties of the secondary battery.

Examples of the additives include at least one selected from the group consisting of a cyclic carbonate-based compound, a halogen-substituted carbonate-based compound, a nitrile-based compound, a sultone-based compound, a sulfate-based compound, a phosphate-based compound, a borate-based compound, a benzene-based compound, an amine-based compound, a silane-based compound, and a lithium salt-based compound.

The cyclic carbonate-based compound may be, for example, vinylene carbonate (VC) or vinylethylene carbonate (VEC).

The halogen-substituted carbonate-based compound may be, for example, fluoroethylene carbonate (FEC).

The nitrile-based compound may be, for example, succinonitrile, adiponitrile, hexantricyanide, or 1,4-dicyano-2-butene.

The sultone-based compound may be, for example, 1,3-propanesultone or 1,3-propenesultone.

The sulfate-based compound may be, for example, ethylene sulfate (Esa), trimethylene sulfate (TMS), or methyl trimethylene sulfate (MTMS).

The phosphate-based compound may be, for example, at least one compound selected from the group consisting of lithium difluoro(bisoxalato)phosphate, lithium difluorophosphate, tetramethyl trimethyl silyl phosphate, trimethyl silyl phosphate, tris(2,2,2-trifluoroethyl)phosphate, and tris(trifluoroethyl)phosphate.

The borate-based compound may be, for example, tetraphenylborate or lithium oxalyldifluoroborate (LiODFB).

The benzene-based compound may be, for example, fluorobenzene, the amine-based compound may be, for example, triethanolamine or ethylenediamine, and the silane-based compound may be, for example, tetravinylsilane.

The lithium salt-based compound is different from the lithium salt contained in the nonaqueous electrolyte, and may be at least one compound selected from the group consisting of LiPO₂F₂, LiODFB, LiBOB (lithium bisoxalatoborate (LiB(C₂O₄)₂), and LiBF₄.

The additives may be used individually, or in a mixture of two or more thereof.

The total amount of the additives may be about 1 wt % to 20 wt %, for example, about 1 wt % to 15 wt % based on the total weight of the electrolyte. When the additives are included in this range, films may be stably formed on the electrodes, the ignition phenomenon may be suppressed in the event of overcharging, the occurrence of side reactions may be prevented during the initial activation of the secondary battery, and the additives may be prevented from being residual or precipitated.

The can-type secondary battery according to an embodiment of the present disclosure is manufactured by inserting the electrode assembly, which is fabricated by disposing the separator between the positive and negative electrodes, into the can-shaped case, injecting the electrolyte thereinto, and sealing the case. Or, the can-type secondary battery is manufactured by fabricating the electrode assembly, impregnating the electrode assembly in the electrolyte, inserting the resulting product into the can-shaped case, and sealing the case.

The can-shaped case according to an embodiment of the present disclosure is cylindrical or prismatic. The electrode assembly described above is mounted in the can-shaped case. According to an embodiment of the present disclosure, the can-type secondary battery is a cylindrical secondary battery. The cylindrical battery has advantages in that it has the high energy density per volume and can be easily manufactured in bulk.

The negative electrode collector according to an embodiment of the present disclosure may be similarly applied to a lithium secondary battery or a sodium secondary battery including the negative electrode collector described above and manufactured using lithium ions or sodium ions as the positive electrode material.

Further, unlike the lithium secondary battery described above, the lithium secondary battery according to another embodiment of the present disclosure may be an all-solid-state battery.

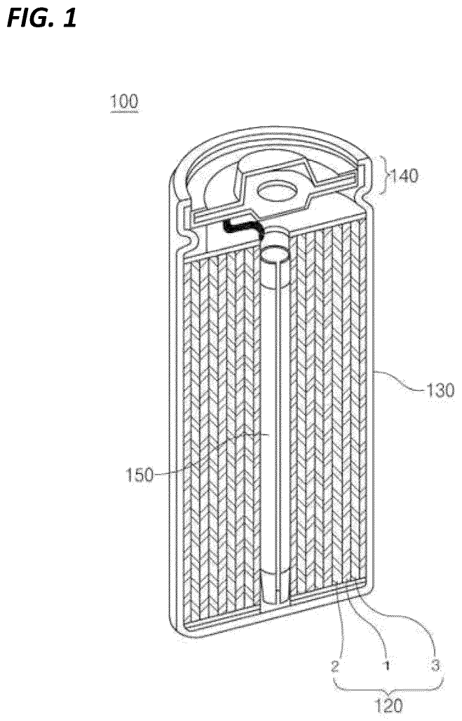

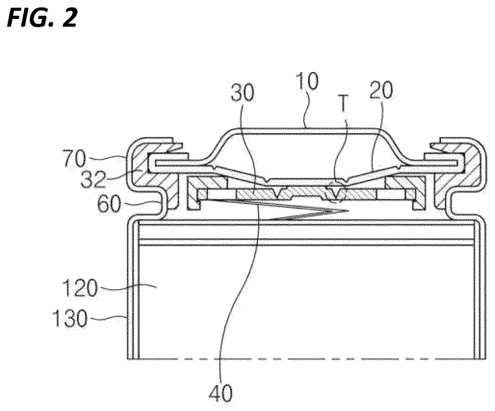

FIG. 1 is a view illustrating a secondary battery according to an embodiment of the present disclosure, and FIG. 2 is a view illustrating the structure of a cap assembly according to an embodiment of the present disclosure. The electrode assembly 120 includes a negative electrode 3, a separator 1, and a positive electrode 2 that are sequentially stacked and wound in a single direction, and the negative electrode 3, the separator 1, and the positive electrode 2 are arranged in the wound shape in the electrode case 130 having a center pin 150 at the center thereof.

A can-shaped case 130 is a container that accommodates an electrode assembly 120 and an electrolyte therein, has an opening at the top thereof, and may be made of a conductive metallic material such as aluminum or steel.

The can-shaped case 130 may include a beading portion 60 and a crimping portion 70, as necessary. The beading portion 60 may be formed by indenting the periphery of the outer circumferential surface of the can-shaped case 130. The beading portion 60 may prevent the electrode assembly 120 accommodated in the can-shaped case 130 from falling out through the opening at the top of the can-shaped case 130, and function as a support on which the cap assembly 140 is securely positioned. The crimping portion 70 may be formed at the top of the beading portion 60, and have a shape that extends and bends to enclose the outer peripheral surface of the cap assembly 140 disposed on the beading portion 60 and a portion of the top surface of the cap assembly 140.

Next, the cap assembly 140 is provided to seal the top opening of the can-shaped case 130, and may include a top cap 10, a safety vent 20, and a CID filter 30 as illustrated in FIG. 2.

The top cap 10 may have a protruding shape to form a positive terminal and include an exhaust port (not illustrated), and the safety vent 20 may be disposed under the top cap 10. The CID filter 30 may be connected to the safety vent 20 at a portion of its upper surface, and connected to the electrode of the electrode assembly 120 at a portion of its lower surface. When a gas occurs from the electrode assembly 120 for causes such as overcharging and a high temperature, resulting in the increase in internal pressure, the safety vent 20 protrudes upward by reversing its shape so that the gas may be exhausted. At this time, the CID filter 30 also moves upward, and as a result, a notch T region breaks, blocking the flow of current. Therefore, further overcharging and explosion of the battery may be prevented.

The cap assembly 140 may further include a gasket 32 that provides an airtight seal between the top cap 10 and the can-shaped case 130, and has the insulation property. The top cap 10 may be pressed onto the beading portion 60 formed in the can-shaped case 130, and fixed by the crimping portion 70. The top cap 10 is a component made of a conductive metallic material, and may cover the top opening of the can-shaped case 130. The top cap 10 may be electrically connected to the positive electrode of the electrode assembly 120, and electrically insulated from the can-shaped case 130 via the gasket 32. Thus, the top cap 10 may function as the positive terminal of the secondary battery. The top cap 10 may have a protrusion projecting upward at the center thereof, and the protrusion may come into contact with an external power source such that current is applied from the external power source.

The secondary battery according to an embodiment of the present disclosure may be applied to not only a battery cell used as a power source of a small device, but also a unit cell of a battery module including a plurality of battery cells for a medium- or large-sized device. Examples of the medium- or large-sized device include electric vehicles, hybrid electric vehicles, plug-in hybrid electric vehicles, and energy storage systems (ESS).

Hereinafter, the present disclosure will be described using Examples. The Examples below are merely examples for facilitating the understanding of the present disclosure, and are not intended to limit the scope of the present disclosure. It is apparent to those skilled in the art that various changes and modifications may be made within the scope of the technical idea of the present disclosure, and the changes and modifications are included in the scope of the claims attached herewith.

### Experimental Example 1: Measurement of Mechanical Properties of Negative Electrode Collector

Commercially available electrolytic copper foils with thicknesses of 4.5 μm, 6 μm, 8 μm, 10 μm, and 12 μm were prepared as negative electrode collectors of Examples 1 to 3 and Comparative Examples 1 to 6. The work hardening exponent, the yield strength, the elastic modulus, the ultimate tensile strength, and the elongation were measured for the electrolytic copper foils of Examples 1 to 3 and Comparative Examples 1 to 6. The work hardening exponent, the yield strength, the elastic modulus, the ultimate tensile strength, and the elongation were measured using an extensometer (manufactured by: ZwickRoell, product name: videoXtens biax 2-150 HP) under the measurement conditions of ASTM D 882. Table 1 herein below provides the results.

### Experimental Example 2: Calculation of Dislocation Density of Negative Electrode Collector

### (1) XRD Analysis of Negative Electrode Collector

The X-ray diffraction (XRD) analysis was performed on each of the electrolytic copper foils of Examples 1 to 3 and Comparative Examples 1 to 6, which were prepared in Experimental Example 1 above. The X-ray diffraction analysis was performed using an X-ray diffraction analyzer (Bruker AXS D4 Endeavor) at 25° C. under the following conditions.
Source: Cu radiation (Kα₁:Kα₂=8:2)
2θ: 40° to 91°
Step size: 0.0015°/s
Total scan time: 168 min
Voltage: 40 kV
Current: 40 mA

### (2) Calculation of Dislocation Density of Negative Electrode Collector

The dislocation density of the negative electrode collector was calculated by measuring the full width at half maximum (FWHM) of each peak by the method described above from the XRD graph obtained by performing the X-ray diffraction analysis on each electrolytic copper foil of Examples 1 to 3 and Comparative Examples 1 to 6, and then, calculating the average of values obtained by the uniform deformation model (UDM), the uniform stress deformation model (USDM), and the uniform deformation energy density model (UDEDM). Table 1 herein below provides the calculation results.

### Experimental Example 3: Observation of Microstructure of Negative Electrode Collector

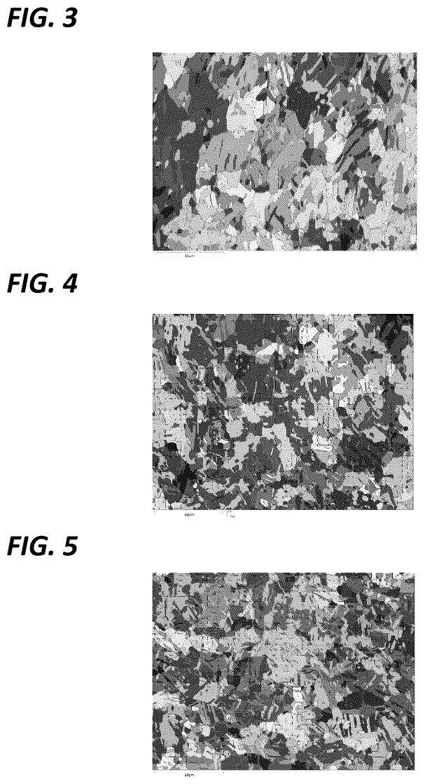

The microstructures of the electrolyzed copper foils of Examples 1 to 3 and Comparative Examples 3 to 4, which were prepared in Experimental Example 1, were observed and illustrated in FIGS. 3 to 7.

FIG. 3 is an EBSD inverse pole figure (IPF) map obtained by capturing an image of the air side of the electrolytic copper foil of Example 1 at a 2000× magnification.

FIG. 4 is an EBSD inverse pole figure (IPF) map obtained by capturing an image of the air side of the electrolytic copper foil of Example 2 at a 2000× magnification.

FIG. 5 is an EBSD inverse pole figure (IPF) map obtained by capturing an image of the air side of the electrolytic copper foil of Example 3 at a 2000× magnification.

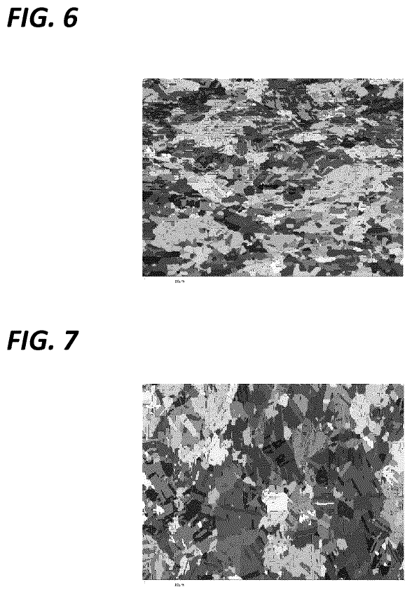

FIG. 6 is an EBSD inverse pole figure (IPF) map obtained by capturing an image of the air side of the electrolytic copper foil of Comparative Example 3 at a 2000× magnification.

FIG. 7 is an EBSD inverse pole figure (IPF) map obtained by capturing an image of the air side of the electrolytic copper foil of Comparative Example 4 at a 2000× magnification.

Further, from the IPF maps, the average size (unit: μm) of the grains at the air side and the drum side of each electrolytic copper foil of Examples 1 to 3 and Comparative Examples 1 to 6 was measured and represented in Table 1 herein below. The average size of the grains indicates the average size of the grains that are clearly separated by the high angle grain boundaries, and may be measured by the method of calculating the misorientation angle using the EBSD.

### Experimental Example 4: Observation of Occurrence of Crack/Short in Negative Electrode Collector of can-Type Secondary Battery

(1) Manufacture of can-Type Secondary Battery

LiCoO₂, polyvinylidenefluoride (PVdF), carbon nanotube (CNT), and carbon black were added to an N-methylpyrrolidone (NMP) solvent in a weight ratio of 97.59:1.18:0.24:0.09 and stirred to prepare a positive electrode slurry. The positive electrode slurry was applied to one side of an aluminum thin film with a thickness of 10 μm at a loading amount of 18.60 mg/cm², and then, dried under vacuum. The dried positive electrode slurry was rolled, dried in a vacuum oven at 130° C. for 6 hours, and then, punched to manufacture the positive electrode.

A negative electrode slurry was applied to one side of each electrolytic copper foil of Examples 1 to 3 and Comparative Examples 1 to 6, which were prepared in Experimental Example 1, and dried under vacuum to manufacture the negative electrode. Specifically, spherical artificial graphite, carbon black, carboxylmethyl cellulose (CMC), and styrene-butadiene rubber (SBR) were added to distilled water in a weight ratio of 97.35:0.5:1.15:1 and stirred to prepare the negative electrode slurry. The negative electrode slurry was applied to one side of each electrolytic copper foil of Examples 1 to 3 and Comparative Examples 1 to 6 at a loading amount of 10.48 mg/cm², and then, dried under vacuum. The dried negative electrode slurry was rolled, followed by a first heat treatment in a vacuum oven at 160° C. for 3 hours, a second heat treatment at 50° C. for 50 minutes, and a third heat treatment at 25° C. for 15 minutes, to manufacture the negative electrode.

A separator was disposed between the manufactured negative electrode and positive electrode to fabricate an electrode assembly, the electrode assembly was positioned in a battery can, and then, an electrolyte was injected into the case to manufacture a battery cell. The electrolyte was prepared by dissolving LiPF₆ at a concentration of 1 M in a mixed organic solvent of ethylene carbonate (EC), dimethyl carbonate (DMC), diethyl carbonate (DEC) with a volume ratio of 1:1:1:1, and adding 5 wt % vinylene carbonate (VC) thereto.

### (2) Observation of Occurrence of Crack/Short, Etc.

Next, while setting one cycle in which a can-type secondary battery manufactured using each electrolytic copper foil of Examples 1 to 3 and Comparative Examples 1 to 6 as the negative electrode collector was charged and discharged within 3.0 V to 4.25 V under conditions of 0.5 C/1.0 C at 45° C., the occurrence of crack/short in the negative electrode was observed during the 500th cycle. Table 1 below provides the observation results.

TABLE 1

| | | Comp. | Comp. | | Comp. | | Comp. | | Comp. | Comp. |
|---|---|---|---|---|---|---|---|---|---|---|
| | | Ex. 1 | Ex. 2 | Ex. 1 | Ex. 3 | Ex. 2 | Ex. 4 | Ex. 3 | Ex. 5 | Ex. 6 |
| Thickness (μm) | | 4.5 | | 6 | 8 | | | 10 | 12 | |
| Work Hardening | | 0.08 | 0.09 | 0.11 | 0.09 | 0.16 | 0.30 | 0.18 | 0.20 | 0.21 |
| Exponent | | | | | | | | | | |
| Dislocation Density | | 2 | 2.1 | 4 | 3 | 4 | 7 | 4 | 4 | 4.3 |
| (×10⁷/mm²) | | | | | | | | | | |
| Yield Strength (kgf/mm²) | | 27 | 27.4 | 31 | 30 | 31 | 35 | 31 | 31 | 31 |
| Elastic Modulus (GPa) | | 130 | 130 | 130 | 130 | 130 | 130 | 130 | 130 | 130 |
| Ultimate Tensile Strength | | 31 | 31.5 | 34 | 32 | 35 | 60 | 36 | 38 | 38.2 |
| (kgf/mm²) | | | | | | | | | | |
| Elongation (%) | | 4 | 5 | 11.5 | 6.7 | 16 | 9 | 17 | 20 | 20.3 |
| Grain | Air Side | 0.70 | 0.68 | 0.66 | 0.70 | 0.68 | 0.40 | 0.70 | 0.70 | 0.70 |
| Average | Drum Side | 0.70 | 0.70 | 0.50 | 0.80 | 0.50 | 0.30 | 0.60 | 0.60 | 0.60 |
| Size (μm) | | | | | | | | | | |

| | | | | | | | | | |
|---|---|---|---|---|---|---|---|---|---|
| Occurrence of | ◯ | ◯ | X | ◯ | X | ◯ | X | — | — |
| Crack/Short | | | | | | | | | |
| Energy Density | 1.03 | 1.03 | 1.02 | 1.00 | 1.00 | 1.00 | 0.98 | 0.96 | 0.96 |

◯: Occurrence of crack/short
X: Non-occurrence of crack/short

As represented in Table 1 above, it may be verified that since the high work hardening performance is achieved in Examples 1 to 3 in which the thickness of the negative electrode collector is 6 μm to 10 μm, and the work hardening exponent “n” is 0.10 to 0.25, the negative electrode collector may be elongated without undergoing crack/short even when deformed into the jelly roll shape and inserted into the can-shaped case.

### Experimental Example 5: Analysis of Texture Coefficient TC of Negative Electrode Collector

From the XRD graph obtained by performing the X-ray diffraction analysis on each electrolytic copper foil of Examples 1 to 3 and Comparative Examples 1 to 6 according to Experimental Example 2 above, TC(111), TC(200), TC(220), and TC(311), defined by Equation 2 below, were calculated. Table 2 below provides the results. 1>

$$TC ( hkl ) = \frac{I ( hkl ) / {I}_{0} ( h k l )}{\frac{1}{4} ( \frac{I ( 111 )}{{I}_{0} ( 111 )} + \frac{I ( 200 )}{{I}_{0} ( 200 )} + \frac{I ( 220 )}{{I}_{0} ( 220 )} + \frac{I ( 311 )}{{I}_{0} ( 311 )} )} \qquad [ Equation 2 ]$$

I(hkl) represents the peak intensity of the (hkl) crystal plane in the XRD graph of the negative electrode collector at 25° C., and I₀(hkl) represents the peak intensity of the (hkl) crystal plane in the XRD graph of a reference sample, in which I₀(111)=100, I₀(200)=46, I₀(220)=20, and I₀(311)=17.

TABLE 2

| | | | | | TC(111)/ |
|---|---|---|---|---|---|
| | TC(111) | TC(200) | TC(220) | TC(311) | TC(200) |
| Example 1 | 0.91 | 0.79 | 0.98 | 1.32 | 1.15 |
| Example 2 | 0.89 | 0.65 | 1.04 | 1.42 | 1.37 |
| Example 3 | 1.00 | 0.78 | 1.04 | 1.18 | 1.28 |
| Comparative | 1.03 | 1.75 | 0.75 | 0.47 | 0.59 |
| Example 1 | | | | | |
| Comparative | 1.08 | 1.68 | 0.75 | 0.49 | 0.64 |
| Example 2 | | | | | |
| Comparative | 0.82 | 2.24 | 0.58 | 0.36 | 0.37 |
| Example 3 | | | | | |
| Comparative | 0.28 | 0.34 | 2.76 | 0.62 | 0.82 |
| Example 4 | | | | | |
| Comparative | 1.19 | 1.01 | 0.92 | 0.88 | 1.18 |
| Example 5 | | | | | |
| Comparative | 1.21 | 1.18 | 0.87 | 0.74 | 1.03 |
| Example 6 | | | | | |

From the calculation results, the ratio of TC(hkl) at each crystal plane to the total sum of TC(111), TC(200), TC(220), and TC(311) (relative texture coefficient) was calculated, and Table 3 below provides the results.

TABLE 3

| | Relative Texture Coefficient (Unit: %) | | | | |
|---|---|---|---|---|---|
| | | | | | TC(220) + |
| | TC(111) | TC(200) | TC(220) | TC(311) | TC(311) |
| Example 1 | 22.75 | 19.75 | 24.5 | 33.0 | 57.5 |
| Example 2 | 22.25 | 16.25 | 26.0 | 35.5 | 61.5 |
| Example 3 | 25.0 | 19.5 | 26.0 | 29.5 | 55.5 |
| Comparative | 25.75 | 43.75 | 18.75 | 11.75 | 30.5 |
| Example 1 | | | | | |
| Comparative | 27.0 | 42.0 | 18.75 | 12.25 | 31.0 |
| Example 2 | | | | | |
| Comparative | 20.5 | 56.0 | 14.5 | 9.0 | 23.5 |
| Example 3 | | | | | |
| Comparative | 7.0 | 8.5 | 69.0 | 15.5 | 84.5 |
| Example 4 | | | | | |
| Comparative | 47.75 | 25.25 | 23.0 | 22.0 | 45.0 |
| Example 5 | | | | | |
| Comparative | 30.25 | 29.5 | 21.75 | 18.5 | 40.25 |
| Example 6 | | | | | |

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A negative electrode collector having a thickness of about 6 μm to 10 μm and a work hardening exponent “n” of about 0.10 to 0.25, wherein the work hardening exponent “n” is defined according to Equation 1 below,
$$σ = K \times ε n \qquad [ Equation 1 ]$$
(in Equation 1 above, “σ” represents a true stress, “K” represents a strength factor, “ε” represents a true strain, and “n” is a work hardening exponent).

2. The negative electrode collector according to claim 1, wherein a dislocation density of the negative electrode collector is about 4×10⁷/mm² or more.

3. The negative electrode collector according to claim 1, wherein a yield strength of the negative electrode collector is about 31 kgf/mm² or more.

4. The negative electrode collector according to claim 1, wherein an elastic modulus of the negative electrode collector is about 130 GPa to 140 GPa.

5. The negative electrode collector according to claim 1, wherein an elongation of the negative electrode collector is about 13% or more.

6. The negative electrode collector according to claim 1, wherein the negative electrode collector includes a copper thin film.

7. The negative electrode collector according to claim 6, wherein the copper thin film is an electrolytic copper foil, and
the electrolytic copper foil includes a drum side and an air side opposite to the drum side.

8. The negative electrode collector according to claim 7, wherein an average size of grains included in the drum side is about 0.50 μm or less.

9. The negative electrode collector according to claim 7, wherein an average size of grains included in the air side is about 0.68 μm or less.

10. The negative electrode collector according to claim 7, wherein an average size of grains included in the drum side is smaller than an average size of grains included in the air side.

11. The negative electrode collector according to claim 1, wherein the negative electrode collector has TC(200) and TC(220) of about 2.20 or less, in which TC(200) and TC(220) are defined by Equation 2 below,
$$T C ( hkl ) = \frac{I ( hkl ) / {I}_{0} ( h k l )}{\frac{1}{4} ( \frac{I ( 111 )}{{I}_{0} ( 111 )} + \frac{I ( 200 )}{{I}_{0} ( 200 )} + \frac{I ( 220 )}{{I}_{0} ( 220 )} + \frac{I ( 311 )}{{I}_{0} ( 311 )} )} \qquad [ Equation 2 ]$$
(in Equation 2 above, I(hkl) represents a peak intensity of a (hkl) crystal plane in an XRD graph obtained by performing an X-ray diffraction analysis on the negative electrode collector at 25° C., and
I₀(hkl) represents a peak intensity of a (hkl) crystal plane in an XRD graph of a reference sample,
in which I₀(111)=100, I₀(200)=46, I₀(220)=20, and I₀(311)=17).

12. The negative electrode collector according to claim 11, wherein the negative electrode collector has TC(111) of about 2.20 or less, in which TC(111) is defined by Equation 2 above.

13. The negative electrode collector according to claim 12, wherein a ratio of TC(111) to TC(200) (TC(111)/TC(200)) is about 0.8 or more.

14. The negative electrode collector according to claim 11, wherein the negative electrode collector has TC(311) of about 2.20 or less, which is defined by Equation 2 above.

15. The negative electrode collector according to claim 11, wherein a ratio of TC(200) to a total sum of TC(111), TC(200), TC(220), and TC(311) defined by Equation 2 above is about 40% or less, and
a ratio of a sum of TC(220) and TC(311) to the total sum of TC(111), TC(200), TC(220), and TC(311) is about 50% or more.

16. The negative electrode collector according to claim 11, wherein a ratio of TC(111) to a total sum of TC(111), TC(200), TC(220), and TC(311) defined by Equation 2 above is about 20% or more.

17. A can-type secondary battery comprising:
an electrode assembly including a negative electrode, a separator, and a positive electrode that are sequentially stacked and wound in one direction; and
a can-shaped case that accommodates the electrode assembly,
wherein the negative electrode includes the negative electrode collector according to claim 1.

18. The can-type secondary battery according to claim 17, wherein the can-shaped case is cylindrical.

19. A method of manufacturing a can-type secondary battery comprising:
an electrode assembly including a negative electrode, a separator, and a positive electrode that are sequentially stacked and wound in one direction; and
a can-shaped case that accommodates the electrode assembly,
wherein the negative electrode includes a negative electrode collector having a thickness of about 6 μm to 10 μm and a work hardening exponent “n” of about 0.10 to 0.25, in which the work hardening exponent “n” is defined according to Equation 1 below,
$$σ = K \times ε n \qquad [ Equation 1 ]$$
(in Equation 1 above, “σ” represents a true stress, “K” represents a strength factor, “ε” represents a true strain, and “n” is a work hardening exponent).

20. The method of manufacturing the can-type secondary according to claim 19, wherein the negative electrode collector has TC(200) and TC(220) of about 2.20 or less, in which TC(200) and TC(220) are defined by Equation 2 below,
$$T C ( hkl ) = \frac{I ( hkl ) / {I}_{0} ( h k l )}{\frac{1}{4} ( \frac{I ( 111 )}{{I}_{0} ( 111 )} + \frac{I ( 200 )}{{I}_{0} ( 200 )} + \frac{I ( 220 )}{{I}_{0} ( 220 )} + \frac{I ( 311 )}{{I}_{0} ( 311 )} )} \qquad [ Equation 2 ]$$
(in Equation 2 above, I(hkl) represents a peak intensity of a (hkl) crystal plane in an XRD graph obtained by performing an X-ray diffraction analysis on the negative electrode collector at 25° C., and
I₀(hkl) represents a peak intensity of a (hkl) crystal plane in an XRD graph of a reference sample,
in which I₀(111)=100, I₀(200)=46, I₀(220)=20, and I₀(311)=17).
